(19) United States
(12) Patent Application Publication
(10) Pub. No.: US 2025/0139629 A1
(43) Pub. Date: May 1, 2025

(54) SECURITY-RELATED RISK DETECTION USING ARTIFICIAL INTELLIGENCE TECHNIQUES

(71) Applicant: Dell Products L.P., Round Rock, TX (US)

(72) Inventors: Suhit Datta, Round Rock, TX (US); Gopal Chandra Haldar, Bangalore (IN); Anvesh Kalia, Round Rock, TX (US); Rakesh Kumar, Jammu (IN); Prateek Srivastava, Cedar Park, TX (US); Kaushik Sharma, Hyderabad (IN); Brian A. White, Austin, TX (US); Narayana Murthy Raju, Coimbatore (IN); Kristin Jean Kevern, Leander, TX (US); Thomas S. Trail, Austin, TX (US); Stephen Patrick Crawley, Round Rock, TX (US); Kathleen Miller, Brooklyn, NY (US); Elena Lazareva, Greensboro, NC (US)

(21) Appl. No.: 18/384,613

(22) Filed: Oct. 27, 2023

(51) Int. Cl. G06Q 20/40

(52) U.S. Cl. CPC G06Q 20/4016; G06Q 20/4014; G06Q 20/4015

(57) ABSTRACT

Methods, apparatus, and processor-readable storage media for security-related risk detection using artificial intelligence techniques are provided herein. An example computer-implemented method includes obtaining data related to at least one user associated with at least one interaction; identifying information pertaining to the at least one user by processing at least a portion of the obtained data using one or more artificial intelligence techniques; determining, based at least in part on at least a portion of the identified information, one or more security risks associated with the at least one user within a context of the at least one interaction; and performing one or more automated actions based at least in part on the one or more determined security risks.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

When interactions are coordinated and/or carried out with various users, there can be a need to identify users and/or aspects or parameters thereof (e.g., users who have full or partial ownership of public companies), as certain interactions with particular types of users may be subject to additional constraints (e.g., legal constraints, regulatory constraints, etc.) and/or risks. Accordingly, a need exists to proactively identify such users. However, conventional user interaction management approaches are resource-intensive and error-prone, often leading to increased security risks.

### SUMMARY

Illustrative embodiments of the disclosure provide techniques for security-related risk detection using artificial intelligence techniques.

An exemplary computer-implemented method includes obtaining data related to at least one user associated with at least one interaction, and identifying information pertaining to the at least one user by processing at least a portion of the obtained data using one or more artificial intelligence techniques. The method additionally includes determining, based at least in part on at least a portion of the identified information, one or more security risks associated with the at least one user within a context of the at least one interaction. Further, the method also includes performing one or more automated actions based at least in part on the one or more determined security risks.

Illustrative embodiments can provide significant advantages relative to conventional user interaction management approaches. For example, problems associated with resource-intensive and error-prone techniques are overcome in one or more embodiments through automatically detecting security-related risk information pertaining to one or more users by leveraging one or more artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for security-related risk detection using artificial intelligence techniques in an illustrative embodiment.

FIG. 2 shows example architecture involving an automated security risk detection system in an illustrative embodiment.

FIG. 3 shows example architecture involving an automated security risk detection system in an illustrative embodiment.

FIG. 4 shows a workflow for generating and implementing a data flag in an illustrative embodiment.

FIG. 5A and FIG. 5B show example pseudocode for example inputs to be utilized in connection with automatically detecting user-related security risks in an illustrative embodiment.

FIG. 6 is a flow diagram of a process for security-related risk detection using artificial intelligence techniques in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

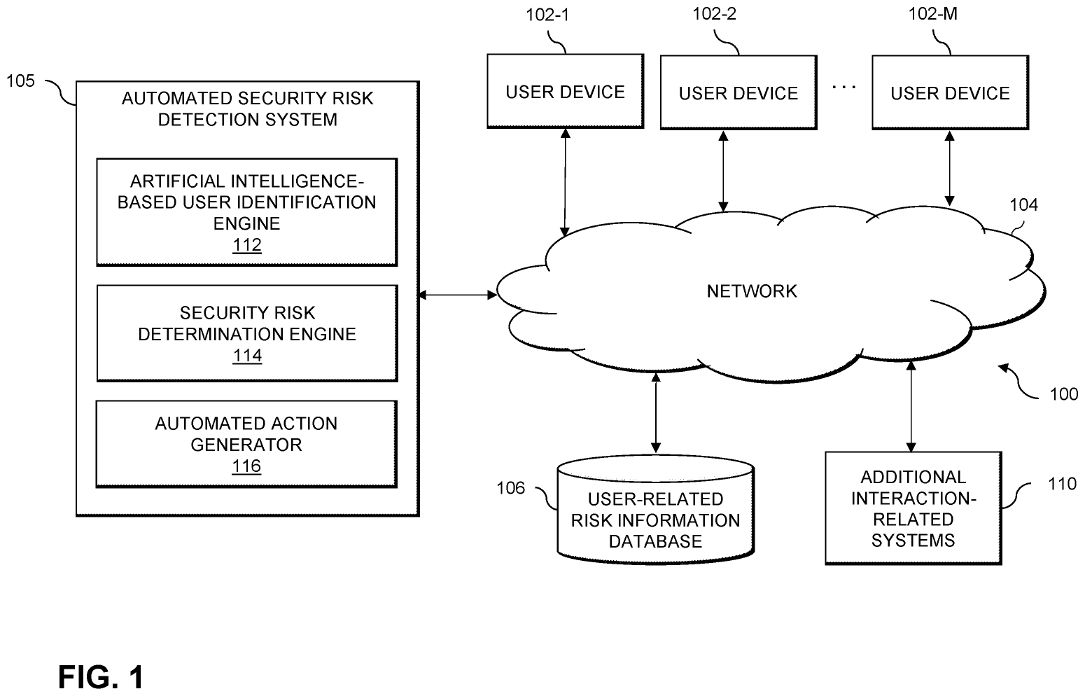

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated security risk detection system 105 and additional interaction-related systems 110, which can include, for example, one or more price quoting systems, one or more account repository systems, etc.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated security risk detection system 105 can have an associated user-related risk information database 106 configured to store data pertaining to one or more users (e.g., identifying information, geographic information, historical user activity data, etc.), data pertaining to one or more security risks (e.g., historical security risk identification data pertaining to users, enterprises and/or companies, geographies, etc.), and/or risk-related action data (e.g., risk remediation data, notification data, etc.).

The user-related risk information database 106 in the present embodiment is implemented using one or more storage systems associated with automated security risk detection system 105. Such storage systems can comprise any of a variety of different types of storage including network-attached storage (NAS), storage area networks (SANS), direct-attached storage (DAS) and distributed DAS, as well as combinations of these and other storage types, including software-defined storage.

Also associated with automated security risk detection system 105 are one or more input-output devices, which illustratively comprise keyboards, displays or other types of input-output devices in any combination. Such input-output devices can be used, for example, to support one or more user interfaces to automated security risk detection system 105, as well as to support communication between automated security risk detection system 105 and other related systems and devices not explicitly shown.

Additionally, automated security risk detection system 105 in the FIG. 1 embodiment is assumed to be implemented using at least one processing device. Each such processing device generally comprises at least one processor and an associated memory, and implements one or more functional modules for controlling certain features of automated security risk detection system 105.

More particularly, automated security risk detection system 105 in this embodiment can comprise a processor coupled to a memory and a network interface.

In one or more embodiments, the processor can illustratively comprise a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions and/or combinations of such circuitry elements.

The memory can illustratively comprise random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as, for example, computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated security risk detection system 105 to communicate over the network 104 with the user devices 102, and illustratively comprises one or more conventional transceivers.

The automated security risk detection system 105 further comprises artificial intelligence-based user identification engine 112, security risk determination engine 114, and automated action generator 116.

It is to be appreciated that this particular arrangement of elements 112, 114 and 116 illustrated in the automated security risk detection system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for security-related risk detection using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated security risk detection system 105, user-related risk information database 106, and additional interaction-related systems 110 can be on and/or part of the same processing platform.

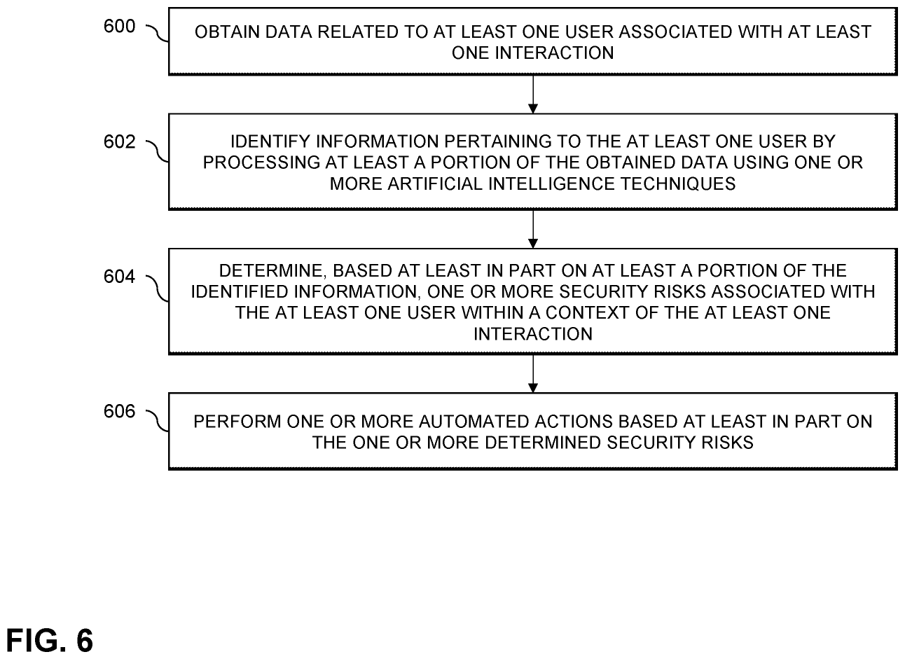

An exemplary process utilizing elements 112, 114 and 116 of an example automated security risk detection system 105 in computer network 100 will be described in more detail with reference to the flow diagram of FIG. 6.

Accordingly, at least one embodiment includes automatically detecting one or more user-related and/or user-specific security-related risks using one or more artificial intelligence techniques. As detailed herein, in various instances and/or contexts, needs can exist in identifying users and/or aspects or parameters thereof ahead of and/or during one or more interactions. In an example use case, there can be a need to identify one or more risks associated with a given user while preparing quotes for the user in connection with a given transaction. To help identify such risks, an example embodiment can include adding pricing details (e.g., maximum pricing details) to the quotes to the user (e.g., a distributor) and informing the user of rights to inspect the pricing provided to one or more additional users associated with the given transaction (e.g., one or more partners of the user). In such an example embodiment, adding maximum pricing details can include providing a directional indication to the end user about setting at least one upper limit on the price that the given product(s) can be sold, and incorporating language indicating the same into the quote(s).

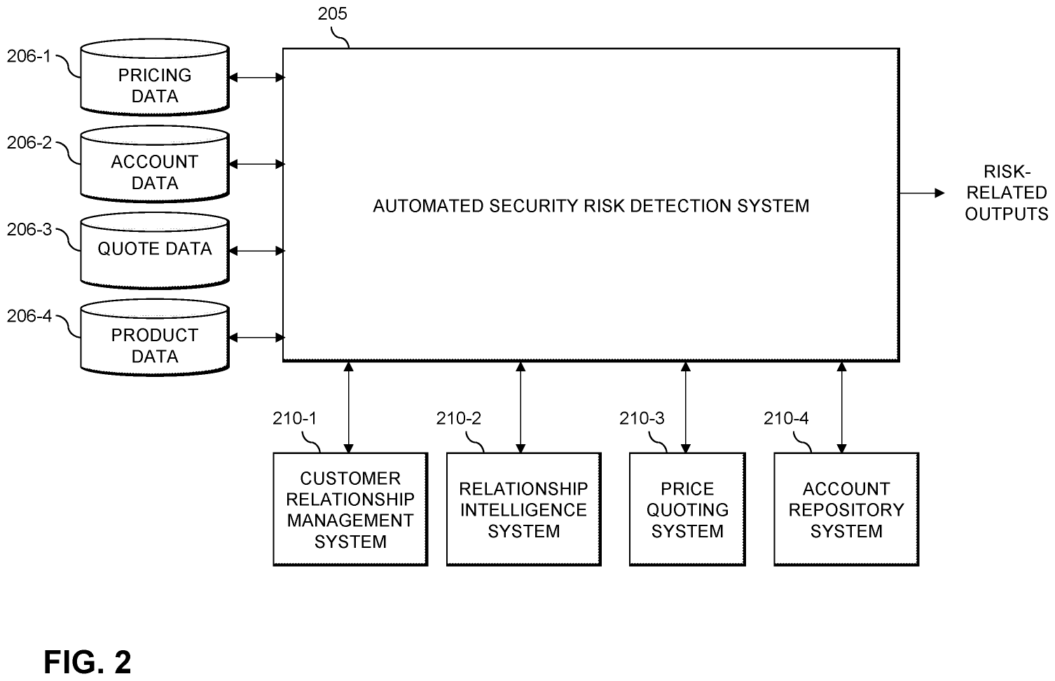

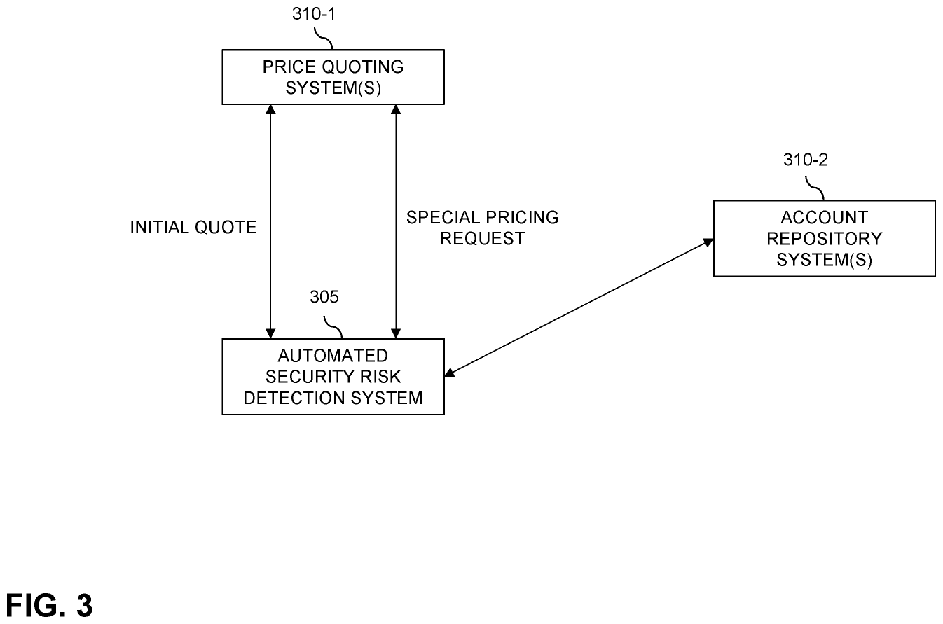

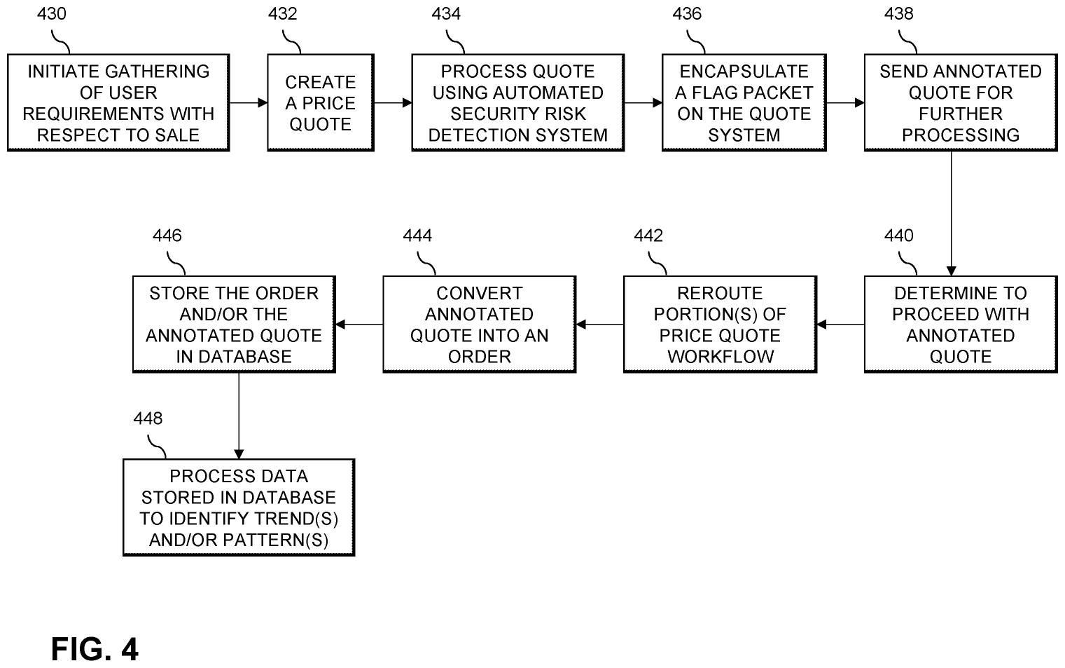

As detailed in connection with, for example, FIG. 1, FIG. 2, FIG. 3 and FIG. 4, one or more embodiments include generating and/or implementing an automated security risk detection system which can enable various systems and/or users (e.g., pricing, audit, and legal teams and/or systems) to drive compliance in connection with user interactions by leveraging artificial intelligence techniques in detecting one or more user-related and/or user-specific security risks. In such an embodiment, an automated security risk detection system can process data pertaining to a given user using one or more artificial intelligence techniques to identify whether the given user meets one or more predetermined and/or predefined risk-related qualifiers and/or parameters (e.g., whether the given user meets a legal definition of a publicly-owned and/or state-owned entity), determining one or more risks related to such an identification, and initiating one or more automated actions based at least in part on such determined risks.

By way of example, in one or more embodiments identifying whether a given user meets one or more predetermined and/or predefined risk-related qualifiers and/or parameters can include processing data pertaining to the given user, as noted above, using one or more artificial intelligence techniques. Such artificial intelligence techniques can include clustering algorithms implemented in connection with at least one density model, at least one hierarchical model, at least one centroid model, and/or at least one distribution model. The above-noted clustering algorithms can include, for example, at least one K-means clustering algorithm, at least one mean-shift algorithm, at least one density-based spatial clustering of applications with noise (DBSCAN) algorithm, at least one balanced iterative reducing and clustering using hierarchies (BIRCH) algorithm, at least one affinity propagation algorithm, at least one ordering points to identify cluster structure (OPTICS) algorithm, at least one divisive hierarchical algorithm, at least one agglomerative hierarchical algorithm, and/or at least one expectation-maximization clustering using Gaussian mixture models algorithm. In one or more embodiments, such a clustering algorithm can be implemented to identify one or more anomalies in the data and flag any discrepancy in one or more predefined parameters.

Additionally, at least one embodiment can include generating one or more flags and/or notifications in connection with any determined risks, and outputting such flags and/or notifications to the one or more additional users related to the given transaction and/or the given user involved in the given transaction. A flag, in connection with one or more embodiments, can include any information about the given transaction that highlights one or more potential risks (e.g., risks determined and/or detected using one or more artificial intelligence techniques, such as further detailed herein). For example, such risk-related information can include the amount of revenue associated with the given transaction, the customer address associated with the given transaction, etc.

One or more embodiments can also include scaling techniques used in identifying whether a given user meets one or more predetermined and/or predefined risk-related qualifiers and/or parameters to fit different demands and/or constraints associated with a given user interaction. In such an embodiment, scaling implies enabling at least one custom configuration of techniques that can be implemented to detect a variety of transaction-related risks and/or security-related risks associated with one or more given transactions. Additionally (such as described in connection with FIG. 1 and FIG. 2, for example), in at least one embodiment, an automated security risk detection system as detailed herein can be integrated into and/or used in conjunction with one or more additional user interaction-related systems (e.g., one or more quoting systems, one or more authentication systems, etc.).

By way merely of example, consider an example use case involving a quoting system and a sales team, implemented in connection with a given interaction with a given user. In one or more embodiments, in such an example use case, utilizing an automated security risk detection system can include implementing messaging and/or flagging capability in connection with the quoting system to educate a sales team while dealing with the given user, which has been identified as a public company and/or an agent thereof. Such a user identification can result in additional security risks being added to the given interaction, and as such, the sales representative involved in preparing the quote can be made aware, via the automated security risk detection system, of the user's status such that the sales representative can choose to proceed in accordance with one or more precautions and/or modifications to the interaction (e.g., flagging a record associated with the interaction as a public company interaction). Additionally or alternatively, the automated security risk detection system can initiate one or more automated actions in response to the user identification, such as, e.g., automatically flagging a record associated with the interaction as a public company interaction, generating and outputting one or more notifications to additional and/or interaction-related users, updating one or more pricing parameters related to one or more risks associated with this particular user identification, etc.

In at least one embodiment, identifying whether the given user meets one or more predetermined and/or predefined risk-related qualifiers and/or parameters can include implementing at least one configurable rule engine. Such a rule engine can be configured, for example, to determine, in part by leveraging one or more artificial intelligence techniques, one or more geography-based parameters in connection with identifying one or more state-owned entities, wherein different geographies can be associated with different risks and/or different risk levels. Such artificial intelligence techniques can include, for example, one or more clustering algorithms (such as detailed above and herein) and/or one or more other types of unsupervised learning techniques (e.g., principal component analysis, independent component analysis, Apriori algorithm, etc.).

Additionally, in one or more embodiments, an automated security risk detection system monitors data streaming through and/or from one or more additional systems (e.g., one or more seller systems, one or more web-based e-commerce systems, one or more accounting systems, etc.), wherein such monitoring can include establishing one or more risk indicators by flagging corresponding interactions (or data related thereto) and determining one or more automated actions to be carried out and/or initiated in connection with such indicators.

FIG. 2 shows example architecture involving an automated security risk detection system in an illustrative embodiment. By way of illustration, FIG. 2 depicts automated security risk detection system 205 processing data from various sources, including pricing data 206-1, account data 206-2, quote data 206-3, and/or product data 206-4. Additionally, FIG. 2 also depicts automated security risk detection system 205 interacting, via the use of one or more application programming interfaces (APIs), with various additional systems including customer relationship management system 210-1, relationship intelligence system 210-2, price quoting system 210-3, and/or account repository system 210-4. Based at least in part on such data processing and/or system interactions, automated security risk detection system 205 generates one or more risk-related outputs pertaining to one or more users or customers and/or one or more given transactions. Such risk-related outputs can be transmitted, for example, to other tools and/or systems such as, e.g., dynamic pricing software and/or systems, data security systems, transaction insight systems, etc. Further, in connection with generating such risk-related outputs, automated security risk detection system 205 can determine and/or generate real-time automated decisions, implement one or more user interfaces for auditing and/or monitoring one or more portions of the above-noted data, and facilitate output feedback and review with one or more systems and/or entities.

FIG. 3 shows example architecture involving an automated security risk detection system in an illustrative embodiment. By way of illustration, FIG. 3 depicts price quoting system(s) 310-1, which can include, for example, one or more sales applications associated with one or more geographic regions, one or more seller quoting tools associated with one or more geographic regions, etc. FIG. 3 also depicts account repository system(s) 310-2, which can include a repository containing information pertaining to various users and one or more risk parameters (e.g., information as to whether a user is a public entity or not, credit information associated with users, billing address information, legal user names, etc.) and a service operating in conjunction with processing such information. For example, when a sales team encounters a new customer, the service incorporated within account repository system(s) 310-2 can help in determining and/or understanding if the customer is a public entity or not based on the information contained within the corresponding repository. In such an example embodiment, the incorporated service can process data from and/or in a pre-existing repository of previously labeled public accounts and determine if the current account exists in this repository.

In an example embodiment such as depicted in FIG. 3, automated security risk detection system 305 can incorporate and/or implement a defined criteria for each quote, provided by price quoting system(s) 310-1, that corresponds to and/or necessitates a public entity user flag and/or annotation. Such criteria can include, for example, that the deal associated with the quote is valued over a given amount, that the deal has been made and/or is being made outside of at least one particular geographic region, that the deal includes a request for special pricing (e.g., pricing below a given value is being requested), etc.

In a scenario wherein automated security risk detection system 305 determines that the criteria are met (e.g., by processing at least a portion of the quote information provided by price quoting system(s) 310-1), automated security risk detection system 305 can then query account repository system(s) 310-2 for information pertaining to the user(s) involved in the deal associated with the quote. Such information can then be processed by automated security risk detection system 305 to detect one or more risk parameters associated with the user(s).

In determining, for example, whether a given user associated with the quote is a public company or agent thereof, automated security risk detection system 305 can seek, from account repository system(s) 310-2, a <Company Number> attributed to the given user. If available, the automated security risk detection system 305 can compare the received <Company Number> against at least one set of known and/or established <Company Number> values associated with public companies.

Additionally, in such an example embodiment, the automated security risk detection system 305 can further check and/or determine if the at least one set of known and/or established <Company Number> values associated with public companies has been updated within a given temporal period (e.g., in the past six months). If yes (that is, the at least one set of known and/or established <Company Number> values associated with public companies has been updated within the given temporal period), then a determination is made, via comparison of the received <Company Number> against at least one set of known and/or established <Company Number> values associated with public companies, as to whether the given user is a public company or agent thereof, and if so, then a flag is generated and associated with the given user (e.g., associated with the received <Company Number>in the account repository system(s) 310-2).

If no (that is, the at least one set of known and/or established <Company Number> values associated with public companies has not been updated within the given temporal period), automated security risk detection system 305 can then request that account repository system(s) 310-2 update the at least one set of known and/or established <Company Number> values associated with public companies. Also, the automated security risk detection system 305 can place the deal on hold until the update has been carried out, and subsequent to the update, a determination can be made, as detailed above, as to whether the given user is a public company or agent thereof.

FIG. 4 shows a workflow for generating and implementing a data flag in an illustrative embodiment. As depicted in FIG. 4, step 430 includes a sales representative initiating a process of gathering requirements of prospective users with respect to one or more sales. Step 432 includes creating a price quote based at least in part on the user requirements. Step 434 includes processing at least a portion of the created price quote using an automated security risk detection system, which can include identifying whether the users associated with the price quote meets one or more predetermined and/or predefined risk-related qualifiers and/or parameters (e.g., whether the given user meets a legal definition of a publicly-owned and/or state-owned entity) and determining one or more risks related to such an identification (e.g., additional precautions and/or actions required, authenticity of a user to be further processed, etc.).

Step 436 includes encapsulating a flag packet on the quote system, wherein the flag packet is generated based at least in part on the processing of the price quote by the automated security risk detection system. The annotated price quote, including the encapsulated flag packet, can then be interpreted by a quote system (which can, for example, proceed with the order in accordance with any conditions included as part of the flag packet). Also, step 438 includes sending the annotated price quote to at least one team and/or automated system for further processing and/or inspection. For example, price quotes involving users identified as public entities can be subject to additional inspection and/or validation.

Step 440 includes at least one representative from the at least one team and/or the automated system determining whether or not to proceed with the annotated price quote (including the flag packet). Step 442 includes rerouting at least a portion of the price quote workflow, if needed. In one or more embodiments, workflow rerouting can include arranging one or more additional meetings and/or interactions with one or more members of a reviewing team and/or leadership to assess the transaction and determine if it makes sense to proceed to the next step of the process.

Step 444 includes creating an order, which can include converting the annotated price quote into an order. By way of illustration, in one or more example embodiments, when a quote is converted into an order, such a conversion implies that a corresponding transaction has been fulfilled and has been paid for by the customer, signifying that the customer agrees to the terms and conditions and the enterprise has received or will receive corresponding payment. Step 446 includes storing the order and/or the annotated price quote in at least one database. Further, step 448 includes performing analysis on at least a portion of the data stored in the database. In at least one example embodiment, such analysis performed in step 448 can include partitioning and/or otherwise processing the at least a portion of data stored in the database to identifying one or more underlying trends and/or patterns (e.g., one or more user buying patterns) across geographies, products, customers, etc.

Additionally, in one or more embodiments, an automated security risk detection system can provision a response received from an account repository service and store such a response in a database (e.g., a database associated with the automated security risk detection system such as user-related risk information database 106 in FIG. 1). The response can also be processed by the automated security risk detection system using artificial intelligence logic, which enables identifying user information. By way merely of example, such artificial intelligence logic can include the following required conditions necessary: Deal value≥$500,000; and Country NOT IN (‘USA,’ ‘Canada’). In an example embodiment, assume that in a response received from an account repository service, the deal value is derived from the selling price, and the country is derived from contact information and/or address information (e.g., via traversing through the contact information hierarchy).

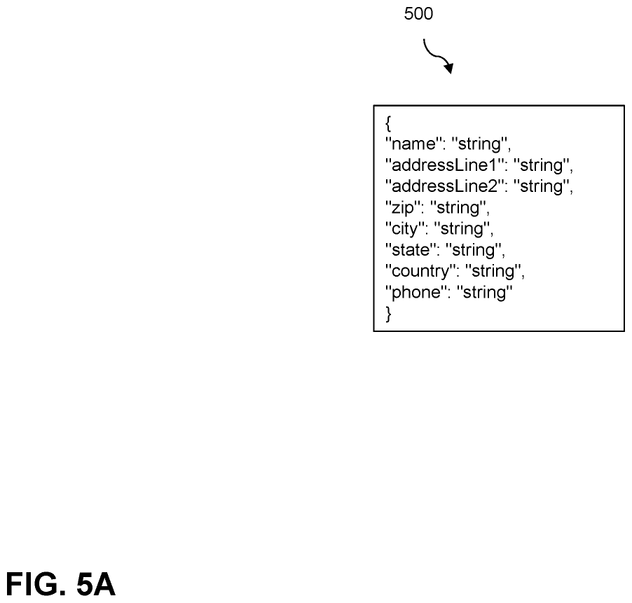

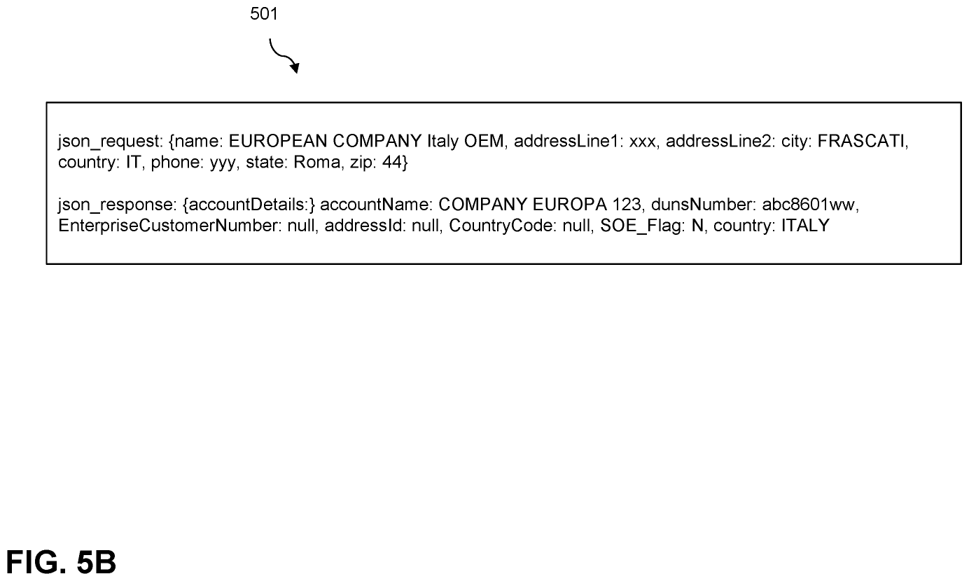

FIG. 5A shows example pseudocode for example inputs to be utilized in connection with automatically detecting user-related security risks in an illustrative embodiment. In this embodiment, example pseudocode 500 is executed by or under the control of at least one processing system and/or device. For example, the example pseudocode 500 may be viewed as comprising a portion of a software implementation of at least part of automated security risk detection system 105 of the FIG. 1 embodiment.

The example pseudocode 500 illustrates a list of inputs, which defines variables as strings, in the given format shown, to be processed by one or more artificial intelligence techniques (e.g., processed by artificial intelligence-based user identification engine 112 in the example embodiment depicted in FIG. 1) to identify at least one user, and/or information associated therewith, related to a given interaction. In at least one embodiment, such artificial intelligence techniques can include one or more natural language processing (NLP) techniques such as, e.g., one or more named entity recognition techniques.

It is to be appreciated that this particular example pseudocode shows just one example implementation of example inputs to be utilized and/or processed in connection with automatically detecting user-related security risks, and alternative implementations can be used in other embodiments.

FIG. 5B shows example pseudocode for example inputs to be utilized in connection with automatically detecting user-related security risks in an illustrative embodiment. In this embodiment, example pseudocode 501 is executed by or under the control of at least one processing system and/or device. For example, the example pseudocode 501 may be viewed as comprising a portion of a software implementation of at least part of automated security risk detection system 105 of the FIG. 1 embodiment.

The example pseudocode 501 illustrates inputs to be processed by one or more artificial intelligence techniques to identify at least one user, and/or information associated therewith, related to a given interaction. Specifically, example pseudocode 501 shows inputs (provided and/or obtained from, for example, an account repository service and/or system) which include a JavaScript Object Notation (JSON) request containing contact information including name information, address line information, zip code information, city information, state information, country information, and phone number information. Additionally, example pseudocode 501 shows a JSON response which includes corresponding account details including account name information, identification number information, enterprise customer number information, address identifier information, country code information, state-owned enterprise flag information, and country information.

It is to be appreciated that this particular example pseudocode shows just one example implementation of example inputs to be utilized and/or processed in connection with automatically detecting user-related security risks, and alternative implementations can be used in other embodiments.

It is to be appreciated that one or more embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the artificial intelligence models described herein may be trained to generate recommendations and/or predictions based on user-specific information and corresponding risk parameter information, and such recommendations and/or predictions can be used to initiate one or more automated actions (e.g., automatically adjusting related user interactions, automatically training one or more artificial intelligence techniques using at least a portion of the recommendations and/or predictions, etc.).

FIG. 6 is a flow diagram of a process for security-related risk detection using artificial intelligence techniques in an illustrative embodiment. It is to be understood that this particular process is only an example, and additional or alternative processes can be carried out in other embodiments.

In this embodiment, the process includes steps 600 through 606. These steps are assumed to be performed by automated security risk detection system 105 utilizing elements 112, 114 and 116.

Step 600 includes obtaining data related to at least one user associated with at least one interaction. In at least one embodiment, obtaining data related to the at least one user associated with the at least one interaction includes interfacing with one or more systems utilized in connection with executing at least a portion of the at least one interaction.

Step 602 includes identifying information pertaining to the at least one user by processing at least a portion of the obtained data using one or more artificial intelligence techniques. In one or more embodiments, identifying information pertaining to the at least one user includes processing, using one or more natural language processing techniques, data related to one or more of user name information, user address information, user billing information, and user contact information.

Additionally or alternatively, identifying information pertaining to the at least one user can include identifying at least one of one or more geography-related parameters associated with the at least one user, one or more enterprise ownership parameters associated with the at least one user, and one or more alphanumeric identifiers associated with the at least one user. In such an embodiment, determining one or more security risks associated with the at least one user within a context of the at least one interaction (such as detailed in connection with step 604) can include determining one or more risk levels associated with each of the one or more geography-related parameters associated with the at least one user, the one or more enterprise ownership parameters associated with the at least one user, and the one or more alphanumeric identifiers associated with the at least one user.

Step 604 includes determining, based at least in part on at least a portion of the identified information, one or more security risks associated with the at least one user within a context of the at least one interaction. In at least one embodiment, determining one or more security risks associated with the at least one user within a context of the at least one interaction includes identifying one or more features of the at least one interaction associated with security risk assessment. In such an embodiment, identifying one or more features of the at least one interaction associated with security risk assessment can include at least one of determining that the at least one interaction involves a transaction valued over a given amount, and that the at least one interaction is to be carried out in accordance with one or more predetermined geographic conditions.

Step 606 includes performing one or more automated actions based at least in part on the one or more determined security risks. In one or more embodiments, performing the one or more automated actions includes automatically annotating data associated with the at least one interaction to indicate that the at least one user is associated with at least one of the one or more determined security risks. Further, in at least one example embodiment, performing the one or more automated actions can include automatically generating and outputting, to one or more additional users associated with the at least one interaction, at least one notification that the at least one user is associated with at least one of the one or more determined security risks. Additionally or alternatively, performing the one or more automated actions can include automatically training at least a portion of the one or more artificial intelligence techniques using feedback related to at least one of the one or more determined security risks and at least a portion of the identified information.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically detect security-related items (e.g., user-specific risks) using artificial intelligence techniques. These and other embodiments can effectively overcome problems associated with resource-intensive and error-prone techniques.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. By way of example, as detailed herein, a given container of cloud infrastructure can illustratively comprise a Docker container and/or other type of Linux Container (LXC). The containers are run on virtual machines in a multi-tenant environment, although other arrangements are possible. Additionally, the containers are utilized to implement a variety of different types of functionality within the system 100. For example, such containers can be used to implement respective processing devices providing compute and/or storage services of a cloud-based system. Again, containers may be used in combination with other virtualization infrastructure such as virtual machines implemented using a hypervisor.

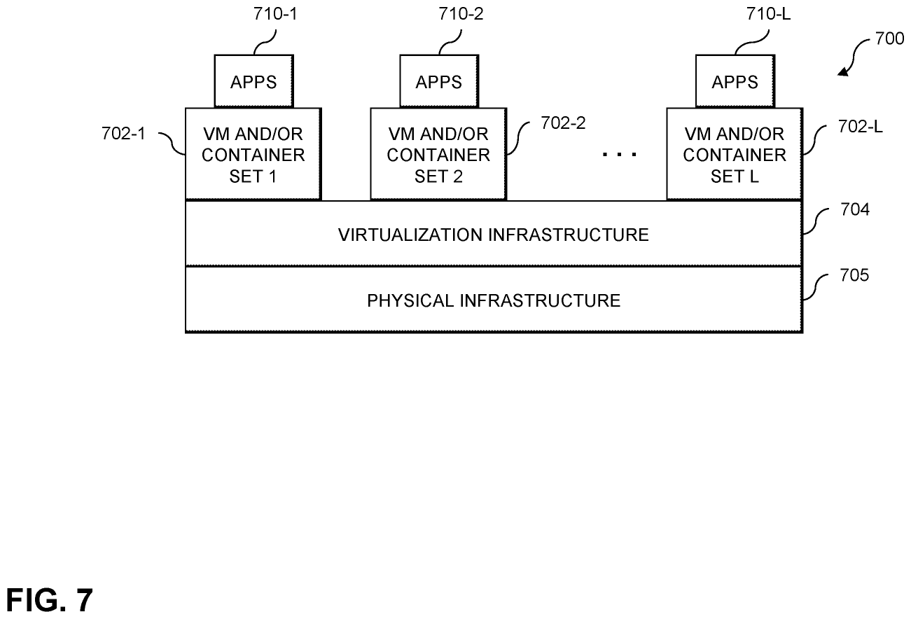

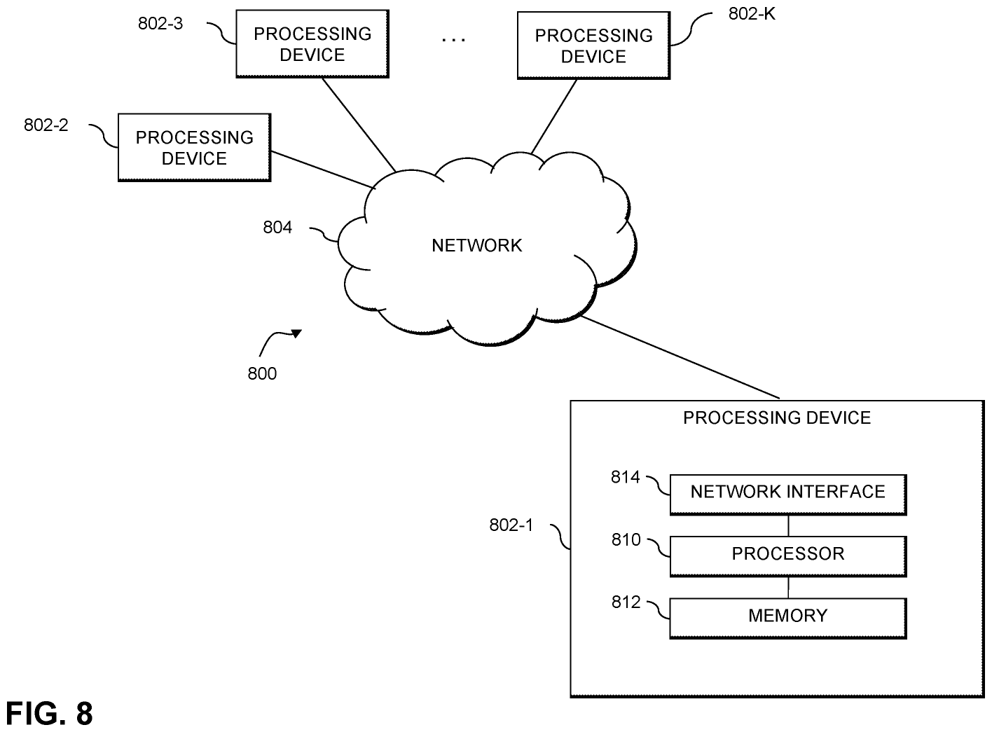

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more information processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a CPU, a GPU, a TPU, a microcontroller, an ASIC, a FPGA or other type of processing circuitry, as well as portions or combinations of such circuitry elements.

The memory 812 can comprise random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

By way of example, particular types of storage products that can be used in implementing a given storage system of an information processing system in an illustrative embodiment can include all-flash and hybrid flash storage arrays, scale-out all-flash storage arrays, scale-out NAS clusters, and/or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data related to at least one user associated with at least one interaction;
identifying information pertaining to the at least one user by processing at least a portion of the obtained data using one or more artificial intelligence techniques;
determining, based at least in part on at least a portion of the identified information, one or more security risks associated with the at least one user within a context of the at least one interaction; and
performing one or more automated actions based at least in part on the one or more determined security risks;
wherein the method is performed by at least one processing device comprising a processor coupled to a memory.

2. The computer-implemented method of claim 1, wherein performing one or more automated actions comprises automatically annotating data associated with the at least one interaction to indicate that the at least one user is associated with at least one of the one or more determined security risks.

3. The computer-implemented method of claim 1, wherein identifying information pertaining to the at least one user comprises processing, using one or more natural language processing techniques, data related to one or more of user name information, user address information, user billing information, and user contact information.

4. The computer-implemented method of claim 1, wherein identifying information pertaining to the at least one user comprises identifying at least one of one or more geography-related parameters associated with the at least one user, one or more enterprise ownership parameters associated with the at least one user, and one or more alphanumeric identifiers associated with the at least one user.

5. The computer-implemented method of claim 4, wherein determining one or more security risks associated with the at least one user within a context of the at least one interaction comprises determining one or more risk levels associated with each of the one or more geography-related parameters associated with the at least one user, the one or more enterprise ownership parameters associated with the at least one user, and the one or more alphanumeric identifiers associated with the at least one user.

6. The computer-implemented method of claim 1, wherein determining one or more security risks associated with the at least one user within a context of the at least one interaction comprises identifying one or more features of the at least one interaction associated with security risk assessment.

7. The computer-implemented method of claim 6, wherein identifying one or more features of the at least one interaction associated with security risk assessment comprises at least one of determining that the at least one interaction involves a transaction valued over a given amount, and that the at least one interaction is to be carried out in accordance with one or more predetermined geographic conditions.

8. The computer-implemented method of claim 1, wherein performing one or more automated actions comprises automatically generating and outputting, to one or more additional users associated with the at least one interaction, at least one notification that the at least one user is associated with at least one of the one or more determined security risks.

9. The computer-implemented method of claim 1, wherein performing one or more automated actions comprises automatically training at least a portion of the one or more artificial intelligence techniques using feedback related to at least one of the one or more determined security risks and at least a portion of the identified information.

10. The computer-implemented method of claim 1, wherein obtaining data related to the at least one user associated with the at least one interaction comprises interfacing with one or more systems utilized in connection with executing at least a portion of the at least one interaction.

11. A non-transitory processor-readable storage medium having stored therein program code of one or more software programs, wherein the program code when executed by at least one processing device causes the at least one processing device:
to obtain data related to at least one user associated with at least one interaction;
to identify information pertaining to the at least one user by processing at least a portion of the obtained data using one or more artificial intelligence techniques;
to determine, based at least in part on at least a portion of the identified information, one or more security risks associated with the at least one user within a context of the at least one interaction; and
to perform one or more automated actions based at least in part on the one or more determined security risks.

12. The non-transitory processor-readable storage medium of claim 11, wherein performing one or more automated actions comprises automatically annotating data associated with the at least one interaction to indicate that the at least one user is associated with at least one of the one or more determined security risks.

13. The non-transitory processor-readable storage medium of claim 11, wherein identifying information pertaining to the at least one user comprises processing, using one or more natural language processing techniques, data related to one or more of user name information, user address information, user billing information, and user contact information.

14. The non-transitory processor-readable storage medium of claim 11, wherein identifying information pertaining to the at least one user comprises identifying at least one of one or more geography-related parameters associated with the at least one user, one or more enterprise ownership parameters associated with the at least one user, and one or more alphanumeric identifiers associated with the at least one user.

15. The non-transitory processor-readable storage medium of claim 11, wherein determining one or more security risks associated with the at least one user within a context of the at least one interaction comprises identifying one or more features of the at least one interaction associated with security risk assessment.

16. An apparatus comprising:
at least one processing device comprising a processor coupled to a memory;
the at least one processing device being configured:
to obtain data related to at least one user associated with at least one interaction;
to identify information pertaining to the at least one user by processing at least a portion of the obtained data using one or more artificial intelligence techniques;
to determine, based at least in part on at least a portion of the identified information, one or more security risks associated with the at least one user within a context of the at least one interaction; and
to perform one or more automated actions based at least in part on the one or more determined security risks.

17. The apparatus of claim 16, wherein performing one or more automated actions comprises automatically annotating data associated with the at least one interaction to indicate that the at least one user is associated with at least one of the one or more determined security risks.

18. The apparatus of claim 16, wherein identifying information pertaining to the at least one user comprises processing, using one or more natural language processing techniques, data related to one or more of user name information, user address information, user billing information, and user contact information.

19. The apparatus of claim 16, wherein identifying information pertaining to the at least one user comprises identifying at least one of one or more geography-related parameters associated with the at least one user, one or more enterprise ownership parameters associated with the at least one user, and one or more alphanumeric identifiers associated with the at least one user.

20. The apparatus of claim 16, wherein determining one or more security risks associated with the at least one user within a context of the at least one interaction comprises identifying one or more features of the at least one interaction associated with security risk assessment.
